(19) United States
(12) Patent Application Publication
(10) Pub. No.: US 2005/0112247 A1
(43) Pub. Date: May 26, 2005

(54) Foodstuff wrapping having a rough and naturally appearing surface

(75) Inventors: Stefanie Stalberg, Taunusstein-Wehen (DE); Christian Aud Der Heide, Osnabrueck (DE); Dirk Auf Der Heide, Alfhausen (DE); Juerg-Heinrich Kallweit, Osnabrueck (DE)

Correspondence Address: CONNOLLY BOVE LODGE & HUTZ LLP, SUITE 800, 1990 M STREET NW, WASHINGTON, DC, 20036-3425, US

(73) Assignee: Kalle GMBH & Co. KG, Wiesbaden (DE)

(21) Appl. No.: 10/505,659

(22) PCT Filed: Feb. 24, 2003
(86) PCT No.: PCT/DE03/00559

(30) Foreign Application Priority Data
Mar. 1, 2002 (DE) 102 08 858.6

(51) Int. Cl. A23G 1/00

(52) U.S. Cl. 426/135

(57) ABSTRACT

A description is given of a single-layer or multilayer food casing made of a thermoplastic mixture which comprises at least one aliphatic polyamide and/or copolyamide, at least one inorganic and/or organic filler and if appropriate at least one aliphatic and/or partially aromatic copolyamide having glycol units and/or polyglycol units. The casing has a maximum surface roughness Rₘₐₓ, determined in accordance with DIN 4768, of 3 to 60 μm, and a water vapor permeability at a mean thickness of 100 μm, determined as specified in DIN 53122, of less than 50 g/m².d. It thus has a particularly matte, rough, and very natural surface structure. The casing is produced by extrusion using an annular die and subsequent film blowing or biaxial stretch orientation. It is suitable as an artificial sausage casing, especially for scalded-emulsion sausage.

The present invention relates to a single-layer or multilayer food casing made of a thermoplastic mixture which comprises at least one aliphatic polyamide and/or copolyamide, and also its use as artificial sausage casing, in particular for smoked scalded-emulsion sausage.

Food casings, especially sausage casings, are produced from natural gut skin, textile skin, fiber skin or cellulose skin, collagen or plastic. Although the collagen or hide-fiber skin is distinguished by a natural surface and a pleasant feel quality, it is produced by a very complex and environmentally polluting process from cattle hides. The hide tissue is digested with acids (for example lactic acid) down to the fibrils; the high-viscosity mass is extruded and slowly and in compact form precipitated and solidified with gaseous ammonia or ammonium hydroxide. During drying, crosslinking (curing) then takes place to give the products sufficient stability, so that they withstand the scalding process without significant loss of strength. Natural gut skins, and also hide-fiber skins, however, are increasingly gaining less acceptance from the final consumers because of various incidents, such as the BSE infection in cattle and the misuse of antibiotics. Furthermore, legal restrictions are threatened. An alternative to said skins is therefore desirable. Cellulose skins, even those with fiber reinforcement, can only take over this task with restrictions. Their production process is also no less complex and environmentally polluting than the collagen process.

Furthermore, cellulose casings and collagen casings not only have high smoke permeability, but also high water vapor permeability. The permeability is generally more than 500 g/m²d. These high values are required for the ripening behavior in uncooked-meat sausage applications, such as salami. However, in the case of smoked scalded-emulsion sausage varieties, they cause excessive drying of the sausage in the scalding process (risk of dry rim formation). Furthermore, unattractive leakage of juice from the sausage occurs in the outer packaging.

Food casings based on synthetic polymers, in contrast, can be a true alternative. These can be produced very simply and without hygiene risks via a combined extrusion and film-blowing process (if appropriate biaxial stretching). However, pure plastic casings, owing to their unnatural, smooth and glossy surface, have not been able to gain acceptance in the market sector for collagen skin or natural gut skin. In addition, they can only store a small amount of water and exhibit only a low permeability for water vapor and smoke.

Plastic casings modified with natural substances are also known. Thus EP-B 0 711 324 describes a reinforced biodegradable non-foamed polymer which contains thermoplastic starch, a hydrophobic biodegradable polymer and a natural fiber such as ramie or sisal. It is used as an engineering plastic for producing shaped bodies. EP-A 0 596 437 describes mixtures of starch or thermoplastic starch with, for example, aliphatic polyesters or poly(vinyl alcohol) which may be processed by thermoplastic extrusion to form water-resistant biodegradable films.

EP-B 0 539 544 discloses a polymer mixture of starch, a plasticizer and a polyolefin. A material made of one or more synthetic polymers, for example a homopolymer or copolymer of hydroxycarboxylic acids, polyurethanes, polyamides and vinyl alcohol copolymers and starch is described in WO 92/19680.

In most uses of this type the biodegradability takes the leading role. Natural appearance and pleasant feel qualities are of secondary importance; the water vapor permeability plays a likewise minor role.

A smoke-permeable food casing is described in EP-A 920 808. As essential constituent it comprises cellulose acetate propionate, if appropriate mixed with an aliphatic polyamide or copolyamide, such as nylon 6, nylon 6/6, nylon 12 or nylon 6/12. It can further comprise plasticizers, such as phthalic acid esters, glycol derivatives or glycerol derivatives.

WO 99/61524 discloses food casings made of a thermoplastic mixture having a polysaccharide component and a plasticizer. They consist of thermoplastic starch or thermoplastic starch derivative and a thermoplastic polyester urethane (TPU). Seamless tubular casings made of this material have small sigma 15 values of about 3 to 4.5; that is to say they are readily deformable and therefore do not exhibit sufficient caliber constancy. The casings have a milky, matte optical appearance. However, they lack the roughness and slightly inhomogeneous structure which make up the natural feel quality of a collagen skin or natural gut skin. In addition, it is disadvantageous that these casings exhibit an undesirably high turbidity, as soon as they are surrounded by an outer packaging of plastic film and as a result are exposed to high atmospheric humidity.

EP-B 0 935 423 discloses a polyamide-based sausage casing which contains block copolymers having hard aliphatic polyamide blocks and soft aliphatic polyether blocks. The water vapor permeability of such casings is about 75 g/m²d. It is thus suitable in principle for smoked scalded-emulsion sausage varieties. However, its very glossy, smooth and artificial-seeming surface is criticized by the end users.

The two last-mentioned plastic casings have not been able to establish themselves as an alternative to a traditional collagen skin or natural gut skin, the former, especially, owing to their deficient caliber stability and their turbidity in the outer packaging, the latter because of their glossy, unnatural appearance.

The object was therefore to provide a food casing which is hygienically safe, simple to produce and which exhibits a particularly matte, rough and natural surface structure. Furthermore, the water vapor permeability (WVP) should be settable in a defined manner, being less than 50 g/m²d. The weight loss with smoked scalded-emulsion sausage varieties is to be small, the tendency to form a dry rim minimal and the loss of juice in the outer packaging is to be negligible. In addition it is to be coilable, able to be cut into hot and it is to be peelable without defect from the food (generally a sausage-meat emulsion).

The object is achieved by incorporating an inorganic and/or organic filler. The filler gives the casing a very natural silky-matte appearance and feel quality. The surface receives a slight roughness, which can be set via the type of filler. In addition, via the filler proportion, the ability of the casing to coil can be influenced. In addition, the filler acts as a reinforcing agent, as a result of which the caliber stability of the filled material is markedly increased compared with the unfilled material. Finally, the fillers, in particular organic fillers, cause increased smoke permeability, which likewise may be set by type and proportion. Some fillers, furthermore, improve the water storage capacity of the casing.

The present invention therefore relates to a single-layer or multilayer food casing made of a thermoplastic mixture having at least one aliphatic polyamide and/or copolyamide and wherein the mixture comprises at least one inorganic and/or organic filler, the casing having a maximum surface roughness Rₘₐₓ, determined in accordance with DIN 4768, of 3 to 60 μm, and a water vapor permeability at a mean thickness of 100 μm, determined as specified in DIN 53122, of less than 50 g/m²d. Preferably, it has a water vapor permeability of 1 to 49 g/m²d. It is thus especially suitable for scalded-emulsion sausage varieties.

In the case of the multilayer casing, the thermoplastic mixture is situated in the outside layer.

Preferred polyamides and/or copolyamides (abbreviated: (co)polyamides) are nylon 6 (poly(ε-caprolactam)=polyamide of ε-caprolactam, or 6-aminohexanoic acid), nylon 6.6 (poly(hexamethylene adipamide)=polyamide of hexamethylene diamide and adipic acid), nylon 6/6.6 (copolyamide of ε-caprolactam, hexamethylenediamine and adipic acid), nylon 6/66.9 (copolyamide of ε-caprolactam, hexamethylenediamine, adipic acid and azelaic acid), nylon 6/66.12 (copolyamide of ε-caprolactam, hexamethylenediamine, adipic acid and laurolactam), nylon 6.9 (polyamide of hexamethylenediamine and azelaic acid), nylon 6.10 (poly(hexamethylenesebacamide=polyamide of hexamethylene-diamine and sebacic acid), nylon 6.12 (poly(hexamethylene dodecanamide)=copolyamide of ε-caprolactam and ω-aminolaurolactam), nylon 4.6 (poly(tetramethylene adipamide)=polyamide of tetramethylenediamine and adipic acid) or nylon 12 (poly(ε-laurolactam)). The (co)polyamide causes especially a higher stiffness of the film.

If appropriate, the thermoplastic mixture additionally further contains at least one aliphatic and/or partially aromatic copolyamide having glycol units and/or polyglycol units (abbreviated: polyether block amide). The polyether block amide is preferably a block copolymer. The polyglycol blocks here generally have 5 to 20 glycol units, preferably about 7 to 15, particularly preferably about 10 glycol units. The term glycol is to be taken to mean here at least dihydric, aliphatic or cycloaliphatic alcohols having 2 to 15 carbon atoms. The terminal hydroxyl groups of the polyglycol blocks can be replaced by amino groups. Such block copolymers are obtainable, for example, under the name ®Jeffamine.

The polyglycol part of the aliphatic or partially aromatic copolyamide can also have ester segments. These consist of units of at least one bifunctional aliphatic alcohol, preferably ethylene glycol or 1,2-propylene glycol (=propane-1,2-diol), and units of at least one dibasic aliphatic, cycloaliphatic or aromatic dicarboxylic acid, preferably adipic acid, sebacic acid or isophthalic acid.

The glycol- or polyglycol-modified copolyamide therefore comprises in a preferred embodiment
a) at least one amide part having units
   a1) of at least bifunctional aliphatic and/or cycloaliphatic amines (especially hexamethylenediamine or isophoronediamine) and of at least bifunctional aliphatic and/or cycloaliphatic and/or aromatic carboxylic acids (especially adipic acid, sebacic acid, cyclohexane-dicarboxylic acid, isophthalic acid or trimellitic acid), or
   a2) of aliphatic aminocarboxylic acids, in particular o)-aminocarboxylic acids, or lactams thereof (especially ε-caprolactam or ω-laurolactam) or
   a3) mixtures of a1) and a2) and
b) at least one glycol or polyglycol part containing units
   b1) of an at least bifunctional aliphatic and/or cycloaliphatic alcohol having 2 to 15 carbon atoms, in particular 2 to 6 carbon atoms (especially ethylene glycol, propane-1,2-diol, propane-1,3-diol, butane-1,4-diol or trimethylolpropane), or
   b2) of at least one oligoglycol or polyglycol of one of the alcohols specified in b1) (especially diethylene glycol, triethylene glycol, polyethylene glycol or poly(1,2-propylene glycol)) or
   b3) of at least one aliphatic oligoglycol or polyglycol of the type specified in b2), the terminal hydroxyl groups of which are replaced by amino groups (Jeffamine) or
   b4) of a mixture of b1), b2) and/or b3) or
   b5) of an ester-containing polyglycol part formed from at least bifunctional aliphatic alcohols (especially ethylene glycol or 1,2-propylene glycol) and at least divalent aliphatic, cycloaliphatic and/or aromatic dicarboxylic acids (especially adipic acid, sebacic acid or isophthalic acid) or
   b6) of a mixture of b1), b2) and/or b5).

Preferably, the modified polyamide contains, in addition to said constituents, no others.

In a preferred embodiment, the thermoplastic mixture consists of at least one (co)polyamide and at least one organic and/or inorganic filler. The amount of (co)polyamide in this case is 50 to 99% by weight, preferably 60 to 98% by weight, particularly preferably 65 to 98% by weight, and the total amount of inorganic and/or organic filler is 1 to 50% by weight, preferably 1 to 40% by weight, particularly preferably 2 to 35% by weight, in each case based on the total weight of the thermoplastic mixture.

In another preferred embodiment, the thermoplastic mixture consists of at least one (co)polyamide and at least one polyether block amide and at least one organic and/or inorganic filler. In this case the amount of (co)polyamide is 35 to 98% by weight, preferably 45 to 97% by weight, particularly preferably 55 to 97% by weight, and the amount of polyether block amide is 1 to 35% by weight, preferably 2 to 30% by weight, particularly preferably 3 to 25% by weight, and the total amount of inorganic and/or organic filler is 1 to 50% by weight, preferably 1 to 40% by weight, particularly preferably 2 to 35% by weight, in each case based on the total weight of the thermoplastic mixture.

The organic filler is, in particular, a carbohydrate. In this case it is preferably a natural polysaccharide and/or a derivative thereof. Branched and crosslinked polysaccharides and derivatives thereof are likewise suitable. Proteins can only be used with restrictions, since, under the high processing temperatures, they are to a large part decomposed.

Particularly suitable polysaccharides are, for example, plant powders, fibers, fibrids or pulp from cellulose. They should have particle sizes or fiber lengths of 5 to 3000 μm, preferably 10 to 1000 μm, particularly preferably 15 to 500 μm. These include plant hairs or seed fibers such as cotton wool, kapok or akon, bast fibers such as flax or linen, hemp, jute, sunn, kenaf, urena, rosella or ramie, hard fibers such as sisal, henequen, manila, fique, phormium, esparto grass, turf, straw or yucca, fruit fibers such as coconut, pineapple, apple or orange, softwood and hardwood fibers such as spruce, pine or cork meal, other plant fibers, for example Tillandsia, and also fibers from wheat, potatoes, tomatoes or carrots.

It is also possible to use native starch, for example from potatoes, manioc, maranta (=arrowroot), sweet potato, wheat, corn, rye, rice, barley, millet, oats, sorghum, chestnuts, acorns, beans, peas, bananas, palm pith (sago). Corn starch is particularly preferred. The ratio of amylose to amylopectin in the various starches can vary. The molecular weight M_{w} is expediently about 50 000 to 10 000 000.

Starch derivatives are, for example, grafted native starches. Grafting agents are, in particular, maleic anhydride, succinic anhydride or Food casing having a rough and natural-seeming surface.

The present invention relates to a single-layer or multilayer food casing made of a thermoplastic mixture which comprises at least one aliphatic polyamide and/or copolyamide, and also its use as artificial sausage casing, in particular for smoked scalded-emulsion sausage.

Food casings, especially sausage casings, are produced from natural gut skin, textile skin, fiber skin or cellulose skin, collagen or plastic. Although the collagen or hide-fiber skin is distinguished by a natural surface and a pleasant feel quality, it is produced by a very complex and environmentally polluting process from cattle hides. The hide tissue is digested with acids (for example lactic acid) down to the fibrils; the high-viscosity mass is extruded and slowly and in compact form precipitated and solidified with gaseous ammonia or ammonium hydroxide. During drying, crosslinking (curing) then takes place to give the products sufficient stability, so that they withstand the scalding process without significant loss of strength. Natural gut skins, and also hide-fiber skins, however, are increasingly gaining less acceptance from the final consumers because of various incidents, such as the BSE infection in cattle and the misuse of antibiotics. Furthermore, legal restrictions are threatened. An alternative to said skins is therefore desirable. Cellulose skins, even those with fiber reinforcement, can only take over this task with restrictions. Their production process is also no less complex and environmentally polluting than the collagen process.

Furthermore, cellulose casings and collagen casings not only have high smoke permeability, but also high water vapor permeability. The permeability is generally more than 500 g/m²d. These high values are required for the ripening behavior in uncooked-meat sausage applications, such as salami. However, in the case of smoked scalded-emulsion sausage varieties, they cause excessive drying of the sausage in the scalding process (risk of dry rim formation). Furthermore, unattractive leakage of juice from the sausage occurs in the outer packaging.

Food casings based on synthetic polymers, in contrast, can be a true alternative. These can be produced very simply and without hygiene risks via a combined extrusion and film-blowing process (if appropriate biaxial stretching). However, pure plastic casings, owing to their unnatural, smooth and glossy surface, have not been able to gain acceptance in the market sector for collagen skin or natural gut skin. In addition, they can only store a small amount of water and exhibit only a low permeability for water vapor and smoke.

Plastic casings modified with natural substances are also known. Thus EP-B 0 711 324 describes a reinforced biodegradable non-foamed polymer which contains thermoplastic starch, a hydrophobic biodegradable polymer and a natural fiber such as ramie or sisal. It is used as an engineering plastic for producing shaped bodies. EP-A 0 596 437 describes mixtures of starch or thermoplastic starch with, for example, aliphatic polyesters or poly(vinyl alcohol) which may be processed by thermoplastic extrusion to form water-resistant biodegradable films.

EP-B 0 539 544 discloses a polymer mixture of starch, a plasticizer and a polyolefin. A material made of one or more synthetic polymers, for example a homopolymer or copolymer of hydroxycarboxylic acids, polyurethanes, polyamides and vinyl alcohol copolymers and starch is described in WO 92/19680.

In most uses of this type the biodegradability takes the leading role. Natural appearance and pleasant feel qualities are of secondary importance; the water vapor permeability plays a likewise minor role.

A smoke-permeable food casing is described in EP-A 920 808. As essential constituent it comprises cellulose acetate propionate, if appropriate mixed with an aliphatic polyamide or copolyamide, such as nylon 6, nylon 6/6, nylon 12 or nylon 6/12. It can further comprise plasticizers, such as phthalic acid esters, glycol derivatives or glycerol derivatives.

WO 99/61524 discloses food casings made of a thermoplastic mixture having a polysaccharide component and a plasticizer. They consist of thermoplastic starch or thermoplastic starch derivative and a thermoplastic polyester urethane (TPU). Seamless tubular casings made of this material have small sigma 15 values of about 3 to 4.5; that is to say they are readily deformable and therefore do not exhibit sufficient caliber constancy. The casings have a milky, matte optical appearance. However, they lack the roughness and slightly inhomogeneous structure which make up the natural feel quality of a collagen skin or natural gut skin. In addition, it is disadvantageous that these casings exhibit an undesirably high turbidity, as soon as they are surrounded by an outer packaging of plastic film and as a result are exposed to high atmospheric humidity.

EP-B 0 935 423 discloses a polyamide-based sausage casing which contains block copolymers having hard aliphatic polyamide blocks and soft aliphatic polyether blocks. The water vapor permeability of such casings is about 75 g/m²d. It is thus suitable in principle for smoked scalded-emulsion sausage varieties. However, its very glossy, smooth and artificial-seeming surface is criticized by the end users.

The two last-mentioned plastic casings have not been able to establish themselves as an alternative to a traditional collagen skin or natural gut skin, the former, especially, owing to their deficient caliber stability and their turbidity in the outer packaging, the latter because of their glossy, unnatural appearance.

The object was therefore to provide a food casing which is hygienically safe, simple to produce and which exhibits a particularly matte, rough and natural surface structure. Furthermore, the water vapor permeability (WVP) should be settable in a defined manner, being less than 50 g/m²d. The weight loss with smoked scalded-emulsion sausage varieties is to be small, the tendency to form a dry rim minimal and the loss of juice in the outer packaging is to be negligible. In addition it is to be coilable, able to be cut into hot and it is to be peelable without defect from the food (generally a sausage-meat emulsion).

The object is achieved by incorporating an inorganic and/or organic filler. The filler gives the casing a very natural silky-matte appearance and feel quality. The surface receives a slight roughness, which can be set via the type of filler. In addition, via the filler proportion, the ability of the casing to coil can be influenced. In addition, the filler acts as a reinforcing agent, as a result of which the caliber stability of the filled material is markedly increased compared with the unfilled material. Finally, the fillers, in particular organic fillers, cause increased smoke permeability, which likewise may be set by type and proportion. Some fillers, furthermore, improve the water storage capacity of the casing.

The present invention therefore relates to a single-layer or multilayer food casing made of a thermoplastic mixture having at least one aliphatic polyamide and/or copolyamide and wherein the mixture comprises at least one inorganic and/or organic filler, the casing having a maximum surface roughness Rₘₐₓ, determined in accordance with DIN 4768, of 3 to 60 μm, and a water vapor permeability at a mean thickness of 100 μm, determined as specified in DIN 53122, of less than 50 g/m²d. Preferably, it has a water vapor permeability of 1 to 49 g/m²d. It is thus especially suitable for scalded-emulsion sausage varieties.

In the case of the multilayer casing, the thermoplastic mixture is situated in the outside layer.

Preferred polyamides and/or copolyamides (abbreviated: (co)polyamides) are nylon 6 (poly(ε-caprolactam)=polyamide of ε-caprolactam, or 6-aminohexanoic acid), nylon 6.6 (poly(hexamethylene adipamide)=polyamide of hexamethylene diamide and adipic acid), nylon 6/6.6 (copolyamide of ε-caprolactam, hexamethylenediamine and adipic acid), nylon 6/66.9 (copolyamide of ε-caprolactam, hexamethylenediamine, adipic acid and azelaic acid), nylon 6/66.12 (copolyamide of ε-caprolactam, hexamethylenediamine, adipic acid and laurolactam), nylon 6.9 (polyamide of hexamethylenediamine and azelaic acid), nylon 6.10 (poly(hexamethylenesebacamide=polyamide of hexamethylene-diamine and sebacic acid), nylon 6.12 (poly(hexamethylene dodecanamide)=copolyamide of ε-caprolactam and ω-aminolaurolactam), nylon 4.6 (poly(tetramethylene adipamide)=polyamide of tetramethylenediamine and adipic acid) or nylon 12 (poly(ε-laurolactam)). The (co)polyamide causes especially a higher stiffness of the film.

If appropriate, the thermoplastic mixture additionally further contains at least one aliphatic and/or partially aromatic copolyamide having glycol units and/or polyglycol units (abbreviated: polyether block amide). The polyether block amide is preferably a block copolymer. The polyglycol blocks here generally have 5 to 20 glycol units, preferably about 7 to 15, particularly preferably about 10 glycol units. The term glycol is to be taken to mean here at least dihydric, aliphatic or cycloaliphatic alcohols having 2 to 15 carbon atoms. The terminal hydroxyl groups of the polyglycol blocks can be replaced by amino groups. Such block copolymers are obtainable, for example, under the name ®Jeffamine.

The polyglycol part of the aliphatic or partially aromatic copolyamide can also have ester segments. These consist of units of at least one bifunctional aliphatic alcohol, preferably ethylene glycol or 1,2-propylene glycol (=propane-1,2-diol), and units of at least one dibasic aliphatic, cycloaliphatic or aromatic dicarboxylic acid, preferably adipic acid, sebacic acid or iso phthalic acid.

The glycol- or polyglycol-modified copolyamide therefore comprises in a preferred embodiment
a) at least one amide part having units
   a1) of at least bifunctional aliphatic and/or cycloaliphatic amines (especially hexamethylenediamine or isophoronediamine) and of at least bifunctional aliphatic and/or cycloaliphatic and/or aromatic carboxylic acids (especially adipic acid, sebacic acid, cyclohexanedicarboxylic acid, isophthalic acid or trimellitic acid), or
   a2) of aliphatic aminocarboxylic acids, in particular co-aminocarboxylic acids, or lactams thereof (especially ε-caprolactam or ω-laurolactam) or
   a3) mixtures of a1) and a2) and
b) at least one glycol or polyglycol part containing units
   b1) of an at least bifunctional aliphatic and/or cycloaliphatic alcohol having 2 to 15 carbon atoms, in particular 2 to 6 carbon atoms (especially ethylene glycol, propane-1,2-diol, propane-1,3-diol, butane-1,4-diol or trimethylolpropane), or
   b2) of at least one oligoglycol or polyglycol of one of the alcohols specified in b1) (especially diethylene glycol, triethylene glycol, polyethylene glycol or poly(1,2-propylene glycol)) or
   b3) of at least one aliphatic oligoglycol or polyglycol of the type specified in b2), the terminal hydroxyl groups of which are replaced by amino groups (Jeffamine) or
   b4) of a mixture of b1), b2) and/or b3) or
   b5) of an ester-containing polyglycol part formed from at least bifunctional aliphatic alcohols (especially ethylene glycol or 1,2-propylene glycol) and at least divalent aliphatic, cycloaliphatic and/or aromatic dicarboxylic acids (especially adipic acid, sebacic acid or isophthalic acid) or
   b6) of a mixture of b1), b2) and/or b5).

Preferably, the modified polyamide contains, in addition to said constituents, no others.

In a preferred embodiment, the thermoplastic mixture consists of at least one (co)polyamide and at least one organic and/or inorganic filler. The amount of (co)polyamide in this case is 50 to 99% by weight, preferably 60 to 98% by weight, particularly preferably 65 to 98% by weight, and the total amount of inorganic and/or organic filler is 1 to 50% by weight, preferably 1 to 40% by weight, particularly preferably 2 to 35% by weight, in each case based on the total weight of the thermoplastic mixture.

In another preferred embodiment, the thermoplastic mixture consists of at least one (co)polyamide and at least one polyether block amide and at least one organic and/or inorganic filler. In this case the amount of (co)polyamide is 35 to 98% by weight, preferably 45 to 97% by weight, particularly preferably 55 to 97% by weight, and the amount of polyether block amide is 1 to 35% by weight, preferably 2 to 30% by weight, particularly preferably 3 to 25% by weight, and the total amount of inorganic and/or organic filler is 1 to 50% by weight, preferably 1 to 40% by weight, particularly preferably 2 to 35% by weight, in each case based on the total weight of the thermoplastic mixture.

The organic filler is, in particular, a carbohydrate. In this case it is preferably a natural polysaccharide and/or a derivative thereof. Branched and crosslinked polysaccharides and derivatives thereof are likewise suitable. Proteins can only be used with restrictions, since, under the high processing temperatures, they are to a large part decomposed.

Particularly suitable polysaccharides are, for example, plant powders, fibers, fibrids or pulp from cellulose. They should have particle sizes or fiber lengths of 5 to 3000 μm, preferably 10 to 1000 μm, particularly preferably 15 to 500 μm. These include plant hairs or seed fibers such as cotton wool, kapok or akon, bast fibers such as flax or linen, hemp, jute, sunn, kenaf, urena, rosella or ramie, hard fibers such as sisal, henequen, manila, fique, phormium, esparto grass, turf, straw or yucca, fruit fibers such as coconut, pineapple, apple or orange, softwood and hardwood fibers such as spruce, pine or cork meal, other plant fibers, for example Tillandsia, and also fibers from wheat, potatoes, tomatoes or carrots.

It is also possible to use native starch, for example from potatoes, manioc, maranta (=arrowroot), sweet potato, wheat, corn, rye, rice, barley, millet, oats, sorghum, chestnuts, acorns, beans, peas, bananas, palm pith (sago). Corn starch is particularly preferred. The ratio of amylose to amylopectin in the various starches can vary. The molecular weight M_{w} is expediently about 50 000 to 10 000 000.

Starch derivatives are, for example, grafted native starches. Grafting agents are, in particular, maleic anhydride, succinic anhydride or ε-caprolactone. Suitable starch derivatives are, in addition, starch esters, in particular starch xanthogenates, acetates, phosphates, sulfates, nitrates, maleates, propionates, butyrates, laurates and oleates. In addition, starch ethers, such as starch methyl ether, ethyl ether, propyl ether, butyl ether, alkenyl ether, hydroxyethyl ether, hydroxypropyl ether. Oxidized starches such as dialdehyde starch, carboxy starch or starch broken down with persulfate are likewise suitable.

In addition, crosslinked carbohydrates can also be used. These are crosslinked, for example, with urea derivatives, urotropin, trioxane, di- or polyepoxides, di- or polychlorohydrins, di- or polyisocyanates, carbonic acid derivatives, diesters or inorganic polyacids, such as phosphoric acid or boric acid.

Substances which are also suitable as filler are natural substances, such as olive stone flour, xanthan, gum arabic, gum gellan, gum ghatti, gum kraya, gum tragacanth, emulsan, rhamsan, wellan, schizophyllan, polygalacturonates, laminarin, amylose, amylopectin and also pectins. It is also possible to use alginic acid, alginates, carrageenan, furcellaran, guar gum, agar agar, tamarind gum, aralia gum, arabinogalactan, pullulan, carob bean gum, chitosan, dextrins, 1,4-α-D-polyglucan. The molecular weight M_{w} of said carbohydrates is generally from 500 to 100 000.

It is also possible to use synthetic fibers or powders (for example polyethylene, polypropylene, polyamide, polyacrylonitrile, polyester fibers). Those which are particularly suitable are synthetic high-temperature-stable fibers or powders based on fluoropolymers, polysulfones, polyether sulfones, polyether ketones, polyphenylene sulfides, polyaramids, polyimides, aromatic polyesters, polyquinoxalines, polyquinolines, polybenzimidazoles, liquid-crystal polymers and conducting polymers, and also carbon fibers. Their fiber length or particle size is generally 5 to 3000 μm, preferably 10 to 1000 μm, particularly preferably 15 to 500 μm.

Suitable inorganic fillers are, in particular, fibers or essentially spherical particles made of glass (for example glass fibers, glass filaments, glass staple fibers), rockwool short fibers (for example basalt wool, slag wool or mineral wool fibers), carbonates (for example chalk, limestone flour, calcite, precipitated calcium carbonate, magnesium carbonate, dolomite or barium carbonate), sulfates (for example barium sulfate or calcium sulfate), silicates (for example talc, pyrophyllite, chlorite, hornblend, mica, kaolin, wollastonite, slate flour, precipitated Ca, Al, Ca/Al, Na/Al silicates, feldspars, mullite, zeolites, silica, quartz, fused quartz, cristobalite, kieselguhr, Neuburger silicon dioxide, precipitated silica, pyrogenic silica, glass flour, pumice flour, perlite, glass (micro)beads (whole glass beads), aluminosilicate hollow beads, Ca metasilicates), or oxides (for example aluminum hydroxide, magnesium hydroxide, titanium dioxide). The fiber length or particle size of the inorganic fillers is generally 0.1 to 3000 μm, preferably 0.1 to 500 μm, particularly preferably 1 to 250 μm.

In a preferred embodiment, the inorganic filler consists of glass microbeads of a mean diameter of 1 to 250 μm, preferably 2 to 150 μm. These are preferably composed of 70 to 73% by weight of SiO₂, 13 to 15% by weight of Na₂O, 7 to 11% by weight of CaO, 3 to 5% by weight of MgO, 0.5 to 2% by weight of Al₂O₃ and 0.20 to 0.60% by weight of K₂O. The surface of the glass microbeads is expediently modified with an adhesion promoter which enhances the adhesion to surrounding polymers. It is possible to use, for example, commercially available glass microbeads which are modified so that they adhere well to acetals, to styrene/acrylonitrile copolymers, acrylonitrile/butadiene/styrene (ABS) copolymers, cellulose, polyesters (especially poly(butylene terephthalate)), polyamides, polyolefins (especially polyethylenes), polycarbonates, poly(methylene(meth)acrylate)s, poly(phenylene oxide)s, polypropylenes, polystyrenes, polysulfones, or poly(vinyl chloride)s.

The roughness of the inventive food casing may be set via the content and particle size of the fillers. It preferably has a maximum surface roughness Rₘₐₓ, (determined in accordance with DIN 4768; E 1989) of 3 to 60 μm, particularly preferably 6 to 45 μm, a mean roughness Rₐ (determined in accordance with DIN 4762; E 1989) of 0.5 to 10 μm, preferably 0.8 to 7 μm, particularly preferably 1.2 to 6.5 μm, and a mean surface roughness R_{z} (determined in accordance with DIN 4768; E 1989) of 1 to 45 μm, preferably 2 to 35 μm, particularly preferably 3 to 32 μm.

A peculiarity of collagen casings is their high water-retention capacity. This effect, in the case of the inventive casing, may be imitated by fillers which are highly swellable and act like superabsorbents. In the case of scalded-emulsion sausages, this decreases the loss of juice in an outer package. Suitable substances are, in particular, sulfate-, carboxylate- or phosphate-containing fillers, or those having quaternary ammonium groups. Likewise, nonionic fillers having high swelling capacity are suitable. The fillers can be crosslinked, uncrosslinked, branched or unbranched. Those which can be used are, for example, natural organic thickeners, such as agar agar, alginates, pectins, carrageenans, tragacanth, gum arabic, guar seed meal, carob bean meal and gelatin, and in addition also modified organic natural substances such as (sodium)carboxymethylcellulose, sodium carboxymethylethylcellulose, methylhydroxyethylcellulose, methylhydroxypropylcellulose, hydroxyethylcellulose and carboxymethyl starch. In addition, it is also possible to use inorganic thickeners (for example silica or polysilica), clay minerals, such as montmorillonite or zeolites. Fully synthetic thickeners which can be used are vinyl polymers, polycarboxylic acids, polyethers, polyimines and polyamides. In addition superabsorbents based on polyacrylate or polymethacrylate can be used.

The total content of filler(s) is generally 1 to 50% by weight, preferably 2 to 40% by weight, particularly preferably 2 to 35% by weight, in each case based on the total weight of the thermoplastic mixture. At a high filler content, the casing may be torn like paper and can be coiled off from the sausage-meat emulsion.

If appropriate, the thermoplastic mixture may also comprise other synthetic polymers. These are in particular ionomers, polymers containing (meth)acrylic esters, or polymers containing vinyl ester units. These polymers are partially incompatible with polyamides, so that a grained inhomogeneous surface structure results. This is absolutely desirable, since the inventive casing then looks more similar to a collagen skin or fiber skin. The casing also as a result becomes softer and less brittle. At a filler content of more than 5% by weight, the casing can otherwise be brittle in some cases.

The ionomer is generally a copolymer having a large content of units of hydrophobic monomers and small amounts of comonomers containing ionic groups. The ionic groups can be bound directly to the main chain of the copolymer. They can also be bound to side chains thereof. Preferred ionomers are ethylene/(meth)acrylic acid copolymers in which some of the carboxyl groups can be present as sodium or zinc carboxylate groups.

The (meth)acrylic ester polymer is preferably an ethylene/methyl acrylate, an ethylene/ethyl acrylate or an ethylene/butyl acrylate copolymer. The vinyl ester polymer is for example a poly(vinyl acetate), an ethylene/vinyl acetate copolymer or a copolymer containing units of vinyl acetate and 2-ethylhexyl acrylate, crotonic acid, vinyl chloride, vinyl laurate, dibutyl maleate, dioctyl maleate or maleic anhydride. It can also be a terpolymer containing units of vinyl acetate, butyl acrylate and N-(2-hydroxyethyl)acrylamide, a terpolymer containing units of vinyl acetate, ethylene and vinyl chloride, or a terpolymer containing units of vinyl acetate, ethylene and acrylamide. The vinyl acetate copolymers also cover partially saponified poly(vinyl acetate)s, also termed poly(vinyl acetate-co-vinyl alcohols).

The content of ionomer, (meth)acrylic ester polymers and/or vinyl ester polymers is generally 1 to 30% by weight, preferably 1.5 to 25% by weight, particularly preferably 2 to 17% by weight.

The addition of a plasticizer is advisable. This simplifies processing on blown-film plants, since the material is less brittle. Furthermore, the better digestion of the filler component gives a more homogeneous film structure, which is desired for certain applications.

Preferred plasticizers are dimethyl sulfoxide (DMSO), butane-1,3-diol, glycerol, water, ethylene glycol, butylene glycol, diglyceride, diglycol ether, formamide, N-methylformamide, N,N-dimethylformamide (DMF), N,N-dimethylurea, N,N-dimethylacetamide, N-methylacetamide, poly(alkylene oxide), glycerol mono-, di- or triacetate, sorbitol, erythritol, mannitol, gluconic acid, galacturonic acid, glucaric acid, glucuronic acid, polyhydroxycarboxylic acids, glucose, fructose, sucrose, citric acid or citric acid derivatives, or poly(vinyl alcohol). Type and amount of plasticizer(s) depend on the fillers chosen in each case and may be optimized by simple preliminary experiments.

The content of plasticizer is up to 30% by weight, preferably 1 to 25% by weight, particularly preferably 2 to 20% by weight, in each case based on the total weight of the thermoplastic mixture.

If desired, the inventive casing can be colored by dyes and/or pigments. On stretching, cavities (vacuoles) can form around the pigment particles. The vacuoles additionally increase the smoke permeability of the film. The dyes or pigments are expediently added to the thermoplastic mixture before extrusion. In addition, if required, additives can be added which affect the sausage-meat emulsion adhesion. In principle, those which are suitable are nitrogenous compounds and carboxyl-group-containing compounds. Improved sausage-meat emulsion adhesion can also be achieved by physical processes such as corona treatment.

The inventive casing can also be multilayered. It then generally comprises 2 to 5 layers. The further layers are, for example, those based on polyolefins and/or polyamides. The filler-containing layer, which gives the casing the desired rough surface structure, forms in this case the outer layer. Between the individual layers, in addition, thin (about 1 to 5 μm thick) layers can also be situated, which contain adhesion promoters. Suitable adhesion promoters are, in particular, polyolefins which are modified with functional groups (for example by grafting with maleic anhydride). Adhesion promoters can equally well also be a constituent of the layers based on polyolefins or polyamides. In a preferred embodiment, at least one adhesion promoter is incorporated into the polyolefin layer. The total thickness of the multilayer casing is generally in the same range as the total thickness of the single-layer casing.

The inventive casing is particularly suitable for hot smoking (above 50 C), and under certain conditions also for warm smoking (25 to 50 C). However, it is less suitable for cold smoking (up to 25 C). The intensity of the smoke aroma and smoke color transferred to the food (this is in particular sausage-meat emulsion) increases with increasing temperature of the smoking gas. Furthermore, the smoke, owing to its aldehydic, phenolic and acid-containing constituents, also has a preservative, antioxidant and solidifying action.

The inventive casing may be produced free of hygienic defects in uniform quality. The production process is considerably simpler than the collagen process. Finally, the casing can be processed for end use using known processes (printing, ring-forming, shirring).

The inventive food casing is produced generally by a blown-tube process or by biaxial stretch orientation. In the case of the blown-tube process, the extruded flexible tube is stretched in the peripheral direction (transverse direction) by inflation and in the longitudinal direction by take-off rolls. Since the shaping takes place immediately from the melt, the degree of orientation of the polymer chains is low. In the case of biaxial stretch orientation, a flexible tube of relatively high wall thickness is first produced by extrusion. This tube is inflated only a little or not at all. Then what is termed the primary tube is cooled. Not until a later step is the primary tube heated to the temperature necessary for the biaxial stretch orientation and then biaxially stretch-orientated by an internally-acting gas pressure and by take-off rolls. By this means a high degree of orientation of the polymer chains is achieved, much higher than in the case of a blown film.

The inventive seamless tubular casing preferably has a thickness of from 40 to 200 μm, when it is made by a blown-tube process, and a thickness of from 25 to 75 μm, when it was obtained by biaxial stretch orientation (double bubble process). Seamless tubular casings which are to be used as artificial sausage casings are preferably produced by biaxial stretch orientation. After the biaxial stretch orientation, expediently there further follows a partial or complete thermosetting. By means of the thermosetting, the casing shrinkage can be set to the desired value. Artificial sausage casings generally have a shrinkage of less than 20% in the longitudinal and transverse directions if they are laid for 1 min in water at 90 C.

The tubular casing can then be further finally processed to give sections tied off at one end. It can also be shirred in sections to give shirred sticks. In addition, it can be bent to form a ring casing. For this the casing is exposed on one side to heat radiation or hot air. Special natural gut skin shapes are also possible, for example the fat end.

Processes and apparatuses for making ring shapes from polymer casings are familiar to those skilled in the art.

The examples hereinafter were produced according to the process 1 or 2 described below and illustrate the invention. Percentages are percentages by weight unless stated otherwise or it is obvious from the context. The components specified in the examples were in each case mixed in a twin-screw extruder and thermally plasticized.

Process 1:

The organic filler was first charged into the extruder and a plasticizer was added. The temperature in the extruder was increased over a plurality of zones from about 90 to about 180 C. The (co)polyamide or the mixture of (co)polyamide and polyether block amide and, if appropriate, further additives were then fed into the extruder and mixed with the remaining constituents at temperatures between 200 and 230 C (depending on the melting point of the polyamide) and the thermoplastic melt formed therefrom was extruded. The extrudate was finally comminuted to form granules.

Process 2:

In this case first the (co)polyamide or the mixture of (co)polyamide and polyether block amide and, if appropriate, further additives was/were fed into the extruder and mixed at temperatures between 200 and 300 C (depending on the melting point of the polyamide). Thereafter, the organic or inorganic filler was added. A plasticizer is not absolutely required in this case. The thermoplastic mixture was finally comminuted to form granules.

The granules were then processed to form a tubular film by a film-blowing process or by biaxial stretch orientation. Multilayer casings were produced by coextrusion using a multilayer die, the filler-containing layer forming the outer layer.

In the examples the following were used:
ethylene/methacrylic acid copolymer, partially neutralized with zinc ions (®Surlyn 9020 and ®Surlyn 1650 from DuPont)
ethylene/methyl acrylate copolymer (containing 24% methyl acrylate) (®Elvaloy 1224AC from DuPont)
ethylene/acrylic acid copolymer (as free acid) (®Nucrel 31001 from DuPont)
nylon 6/poly(ethylene glycol) block copolymer (®Pebax MH 1657 SA from Elf Atochem S.A.)
nylon 12/poly(ethylene glycol) block copolymer (®Pebax MV 1074 SA from Elf Atochem S.A.)
nylon 6/6.6 (®Ultramid C4 from BASF Aktiengesellschaft)
nylon 6 (®Grilon F40 from Ems Chemie AG)
nylon 6.6 (®Ultramid A5 from BASF Aktiengesellschaft)
nylon 12 (®Grilamid L25 from Ems Chemie AG)

Composition and properties of the tubular casings according to examples 1 to 14 are compiled in tables 2 and 3.

TABLE 1

| | 1 | | | 4 |
|---|---|---|---|---|
| | Thermoplastic | 2 | 3 | Further |
| | mixture | Filler | Plasticizer | additives |
| a | (co)polyamide | polysaccharide or | plasticizer | ionomers |
| | for stability | inorganic filler | | and/or |
| | and sausage- | | | (meth)acrylic |
| | meat emulsion | | | ester polymers |
| | adhesion | | | and/or |
| | | | | vinyl ester |
| | | | | polymers |
| b | blend of | natural feel | suppleness | natural |
| | (co)polyamide and | properties/optical | | graininess |
| | glycol- or | properties | | |
| | polyglycol- | coiling ability | digestion | inhomogeneous |
| | modified | water-vapor | of the | surface |
| | polyamide | and smoke | natural | structure |
| | for stability, | permeability | material | reduction of |
| | sausage-meat | control of | | brittleness |
| | emulsion | the water- | | |
| | adhesion, | retention | | |
| | water-vapor | capacity | | |
| | and improved | | | |
| | smoke | | | |
| | permeability | | | |

The following raw Material combinations are conceivable:
[1](a)+[2] //[1](b)+[2] //[1](a)+[2]+[3] //[1](b)+[2]+[3](a)+[2]+[4] //[1](b)+[2]+[4] //[1]l (a)+[2]+[3]+[4] //[1](b)+2]+[3]+[4]

TABLE 2

| Example | Thermoplastic component | | Filler | | Plasticizer | | Process |
|---|---|---|---|---|---|---|---|
| 1 | | | 4% by wt. | Quartz flour | | | |
| | 87.0% by wt. | Ultramid A5 | 9% by wt. | Glass microbeads | — | — | 2 |
| 2 | 97.0% by wt. | Ultramid A5 | 3% by wt. | Calcium carbonate | — | — | 2 |
| 3 | 58.5% by wt. | Ultramid C4 | 4% by wt. | Cellulose powder | | | |
| | 18.0% by wt. | Grilon CF6S | | | 6% by wt. | Glycerol | 1 |
| | 13.5% by wt. | Pebax MH 1657 | | | | | |
| 4 | 96.0% by wt. | Ultramid C4 | 4% by wt. | Cellulose powder | — | — | 2 |
| 5 | 62.5% by wt. | Ultramid C4 | 4% by wt. | Cellulose powder | — | — | |
| | 19.0% by wt. | Grilon CF6S | | | | | 2 |
| | 14.5% by wt. | Pebax MH 1657 | | | | | |
| 6 | 70.0% by wt. | Grilamid L25 | 5% by wt. | Guar seed meal | — | — | 2 |
| | 25.0% by wt. | Pebax MV 1074 | | | | | |
| 7 | 80.0% by wt. | Grilon F40 | 10% by wt. | Maize starch | 3% by wt. | Glycerol | 1 |
| | 7.0% by wt. | Pebax MH 1657 | | | | | |
| 8 | 61% by wt. | Ultramid A5 | 9% by wt. | Glass microbeads | | | |
| | 15% by wt. | Nucrel 31001 | 4% by wt. | Quartz flour | — | — | 2 |
| | 11% by wt. | Grilon F 40 | | | | | |
| 9 | 71% by wt. | Ultramid A5 | 9% by wt. | Glass microbeads | | | |
| | 5% by wt. | Elvaloy AC 1224 | 4% by wt. | Quartz flour | — | — | 2 |
| | 11% by wt. | Grilon F 40 | | | | | |
| 10 | 71% by wt. | Ultramid A5 | 9% by wt. | Glass microbeads | | | |
| | 5% by wt. | Surlyn 9020 | 4% by wt. | Quartz flour | — | — | 2 |
| | 11% by wt. | Grilon F 40 | | | | | |
| 11 | 66% by wt. | Ultramid A5 | 9% by wt. | Glass microbeads | | | |
| | 10% by wt. | Surlyn 9020 | 4% by wt. | Quartz flour | — | — | 2 |
| | 11% by wt. | Grilon F 40 | | | | | |
| 12 | 67% by wt. | Ultramid C4 | 4% by wt. | Cellulose powder | | | |
| | 10% by wt. | Nucrel 31001 | | | 4% by wt. | Glycerol | 1 |
| | 15% by wt. | Pebax MH 1657 | | | | | |
| 13 | 72% by wt. | Ultramid C4 | 4% by wt. | Cellulose powder | | | |
| | 10% by wt. | Surlyn 1650 | | | 4% by wt. | Glycerol | 1 |
| | 10% by wt. | Pebax MH 1657 | | | | | |
| 14 | 69% by wt. | Ultramid C4 | | | | | |
| | 5% by wt. | Surlyn 1650 | 10% by wt. | Maize starch | 6% by wt. | Glycerol | 1 |
| | 10% by wt. | Pebax MH 1657 | | | | | |

TABLE 3

| | | σ₁₅ value)² | Tear strength)2 | Elongation at | | | |
|---|---|---|---|---|---|---|---|
| | | longitudinal/ | longitudinal/ | break)2 | Roughness | | Film |
| Example | WVP)¹ | transverse | transverse | longitudinal/transverse | Ra/Rz/Rmax | Glossiness | thickness |
| No. | [g/m2d] | [N/mm2] | [N/mm2] | [%] | [μm] | 20°/60°/85° | [μm] |
| 1 | 10 | 19/19 | 24/23 | 85/71 | 2/8.4/16.9 | 6.3/29.1/22.2 | 89 |
| 2 | 8 | 41/30 | 37/30 | 109/99 | 1.2/5.9/8.3 | 7.4/39.4/26.1 | 90 |
| 3 | 49 | 16/15 | 54/53 | 451/489 | 2.0/10.5/14 | 0.5/6.0/4.2 | 80 |
| 4 | 40 | 20/18 | 60/52 | 490/460 | 1.9/10.1/13 | 0.6/6.1/4.5 | 70 |
| 5 | 48 | 16/15 | 54/49 | 434/440 | 2.1/11/15 | 0.5/6.3/4.3 | 64 |
| 6 | 16 | 18/17 | 50/49 | 401/395 | 1.8/9.7/12.5 | 0.7/7.0/5.2 | 75 |
| 7 | 30 | 20/19 | 52/50 | 397/396 | 0.7/3.0/4.8 | 4.5/23.1/16.2 | 52 |
| 8 | 11 | 16/16 | 25/20 | 150/100 | 2.9/14.8/23.9 | 5.8/25.1/19.2 | 90 |
| 9 | 11 | 19/17 | 26/23 | 140/90 | 1.9/10.7/13.4 | 6.4/30.0/22.1 | 90 |
| 10 | 11 | 16/15 | 25/22 | 120/80 | 2.1/12.3/19.8 | 6.5/27.0/20.2 | 90 |
| 11 | 10 | 18/17 | 26/20 | 120/60 | 2.2/9.3/14.0 | 6.0/25.9/20.1 | 96 |
| 12 | 38 | 15/14 | 50/48 | 425/410 | 2.0/9.8/12.7 | 0.6/6.5/4.4 | 70 |
| 13 | 30 | 16/16 | 52/49 | 401/392 | 1.8/9.7/12.5 | 0.5/6.2/4.1 | 70 |
| 14 | 48 | 19/19 | 49/47 | 380/370 | 0.8/3.1/5.0 | 4.2/22.1/15.4 | 60 |

)¹WVP = water vapor permeability. The casing was charged at one end with air of a relative humidity of 85% at 23 C.; the water vapor permeability was determined as specified in DIN 53 122.
)²Examples 1, 2 and 8 to 11 were determined as specified in DIN 53 455 on wet samples of width 15 mm at a clamped length of 50 mm, examples 3 to 7 and 12 to 14 on dry samples.

### COMPARATIVE EXAMPLE 1 (WO 99/61524)

As described in the examples above, a tubular film was produced from a thermoplastic mixture of the type specified in WO 99/61524. The mixture specifically contained the following:

| | |
|---|---|
| 42% by weight | of thermoplastic polyesterurethane |
| 35% by weight | of corn starch |
| 23% by weight | of glycerol |

The finished film had a thickness of 120 μm. Its σ₁₅ value was 4.2 N/mm² and its water vapor permeability was 200 g/m²d. The roughness parameters Rₐ/R_{z}/Rₘₐₓ were 0.3/1.8/2.4 μm.

Despite a higher thickness, this film had a lower mechanical stability (recognizable from the sigma-15 value) than that of the inventive film. In addition, the roughness of the casing was markedly less.

### COMPARATIVE EXAMPLE 2 (EP-A 935 423)

As described above, a tubular film was produced from a thermoplastic mixture of the following composition:

| | |
|---|---|
| 38% by weight | of Grilon F40 |
| 27% by weight | of Ultramid C4 |
| 35% by weight | of Grilon FE 7012 |

The finished film had a thickness of 25 μm and a water vapor permeability of 75 g/m²d. The roughness parameters Rₐ/R_{z}/Rₘₐₓ were 0.5/3.0/3.7 and the glossiness at 20/60/85 was 13.5/82.1/87.6.

The inventive film, in contrast, had a markedly lower water vapor permeability, a glossiness lower by some orders of magnitude and a more natural roughness.

1. A single-layer or multilayer food casing made of a thermoplastic mixture having at least one aliphatic polyamide and/or copolyamide, wherein the mixture comprises at least one inorganic and/or organic filler, the casing having a maximum surface roughness Rₘₐₓ, determined in accordance with DIN 4768, of 3 to 60 μm, and a water vapor permeability at a mean thickness of 100 μm, determined as specified in DIN 53122, of less than 50 g/m²d.

2. The food casing as claimed in claim 1, wherein it has a water vapor permeability, determined as specified in DIN 53122, of 1 to 49 g/m²d.

3. The food casing as claimed in claim 1, wherein the (co)polyamide is nylon 4.6, nylon 6, nylon 6.6, nylon 6/6.6, nylon 6.9, nylon 6.10, nylon 6.12, nylon 6/66.9, nylon 6/66.12 or nylon 12.

4. The food casing as claimed in claim 1, wherein the thermoplastic mixture additionally comprises at least one aliphatic and/or partly aromatic copolyamide having glycol units and/or polyglycol units.

5. The food casing as claimed in claim 4, wherein the aliphatic and/or partly aromatic copolyamide having glycol and/or polyglycol units has
a) at least one amide part having units
a1) of at least bifunctional aliphatic and/or cycloaliphatic amines and of at least bifunctional aliphatic and/or cycloaliphatic and/or aromatic carboxylic acids, or
a2) of aliphatic aminocarboxylic acids or lactams thereof or
a3) mixtures of a1) and a2) and
b) at least one glycol or polyglycol part containing units
b1) of an at least bifunctional aliphatic and/or cycloaliphatic alcohol having from 2 to 15 carbon atoms, in particular from 2 to 6 carbon atoms, or
b2) of at least one oligoglycol or polyglycol of one of the alcohols specified in b1) or
b3) of at least one aliphatic oligoglycol or polyglycol of the type specified in b2), the terminal hydroxyl groups of which are replaced by amino groups or
b4) of a mixture of b1), b2) and/or b3) or
b5) of an ester-containing polyglycol part formed from at least bifunctional aliphatic alcohols and at least divalent aliphatic, cycloaliphatic and/or aromatic dicarboxylic acids or
b6) of a mixture of b1), b2) and/or b5).

6. The food casing as claimed in claim 1, wherein the amount of (co)polyamide is 50 to 99% by weight, and the total amount of inorganic and/or organic filler is 1 to 50% by weight, in each case based on the total weight of the thermoplastic mixture.

7. The food casing as claimed in claim 4, wherein the amount of (co)polyamide is 35 to 98% by weight, the amount of polyether block amide is 1 to 35% by weight, and the amount of filler is 1 to 50% by weight, in each case based on the total weight of the thermoplastic mixture.

8. The food casing as claimed in claim 1, wherein the organic filler is a carbohydrate.

9. The food casing as claimed in claim 1, wherein the filler is highly swellable.

10. The food casing as claimed in claim 1, wherein the inorganic filler comprises fibers and/or spheres.

11. The food casing as claimed in claim 10, wherein the fiber length or particle size of the inorganic filler is 0.1 to 3000 μm.

12. The food casing as claimed in claim 10, wherein the fibers and/or spheres comprise glass microbeads having a mean particle size of 1 to 250 μm.

13. The food casing as claimed in claim 12, wherein the surface of the glass microbeads is modified with an adhesion promoter which enhances the adhesion to surrounding polymers.

14. The food casing as claimed in claim 1, wherein the thermoplastic mixture additionally comprises at least one ionomer, a (meth)acrylic ester polymer and/or a vinyl ester polymer.

15. The food casing as claimed in claim 14, wherein the ionomer is an ethylene/(meth)acrylic acid copolymer in which some of the carboxyl groups are if appropriate present as zinc or sodium carboxylate groups.

16. The food casing as claimed in claim 14, wherein the (meth)acrylic ester copolymer is an ethylene/methyl acrylate, ethylene/ethyl acrylate and/or an ethylene/butyl acrylate copolymer.

17. The food casing as claimed in claim 14, wherein the vinyl ester polymer is a poly(vinyl acetate), an ethylene/vinyl acetate copolymer, a copolymer containing units of vinyl acetate and 2-ethylhexyl acrylate, crotonic acid, vinyl chloride, vinyl laurate, dibutyl maleate, dioctyl maleate or maleic anhydride, a terpolymer containing units of vinyl acetate, butyl acrylate and N-(2-hydroxyethyl)acrylamide, a terpolymer containing units of vinyl acetate, ethylene and vinyl chloride, or a terpolymer containing units of vinyl acetate, ethylene and acrylamide.

18. The food casing as claimed in claim 14, wherein the content of ionomer, (meth)acrylic ester polymer and/or vinyl ester polymer is 1 to 30% by weight, based on the total weight of the thermoplastic mixture.

19. The food casing as claimed in claim 1, additionally comprising a plasticizer, the content of plasticizer being up to 30% by weight, based on the total weight of the thermoplastic mixture.

20. A process for producing a food casing as claimed in claim 1, which comprises extruding or coextruding the thermoplastic mixture having at least one aliphatic polyamide and/or copolyamide and at least one inorganic and/or organic filler and blow-forming or biaxially stretch-orienting the resultant flexible tube.

21. The process as claimed in claim 20, wherein the flexible tube is finally processed to give sections tied off at one end or to give a shirred stick.

22. The process as claimed in claim 20, wherein the flexible tube is further processed to give a natural gut-skin-like shape.

23. An artificial sausage casing, preferably for scalded-emulsion sausage comprising a food casing as claimed in claim 1.

24. A single-layer or multilayer food casing made of a thermoplastic mixture having at least one aliphatic polyamide and/or copolyamide, wherein the mixture comprises at least one inorganic and/or organic filler, the casing having a maximum surface roughness Rₘₐₓ, determined in accordance with DIN 4768, of 6 to 60 μm, a mean roughness Rₐ determined in accordance with DIN 4762, of 1.2 to 10 μm, and a water vapor permeability at a mean thickness of 100 μm, determined as specified in DIN 53122, of less than 50 g/m²d.

25. A food casing of claim 9 wherein said fibers and/or spheres are selected from the group consisting of glass filaments, glass staple fibers, glass microbeads, mineral wool fibers, short mineral wool fibers, carbon fibers, zeolites, quartz, aluminosilicate hollow beads, silicon dioxide, silicic acids, sulfates, preferably barium sulfate or calcium sulfate, carbonates, preferably calcium carbonate and magnesium carbonate, aluminum hydroxide, oxides, preferably titanium dioxide, talc, clay and mica.

26. A food casing of claim 12 wherein said glass microbeads comprise on average of 70 to 73% by weight of SiO₂, 13 to 15% by weight of Na₂O, 7 to 11% by weight of CaO, 3 to 5% by weight of MgO, 0.5 to 2.0% by weight of Al₂O₃ and 0.20 to 0.60 of K₂O.
